(19) United States
(12) Patent Application Publication
(10) Pub. No.: US 2017/0227130 A1
(43) Pub. Date: Aug. 10, 2017

(54) VALVE DEVICE FOR A MOTOR VEHICLE

(71) Applicant: CONTINENTAL AUTOMOTIVE GMBH, Hannover (DE)

(72) Inventors: Peter Kohlen, Neu Anspach (DE); Rainer Johannes Montigny, Bad Soden (US)

(73) Assignee: CONTINENTAL AUTOMOTIVE GMBH, Hannover (DE)

(21) Appl. No.: 15/581,547

(22) Filed: Apr. 28, 2017

Related U.S. Application Data
(63) Continuation of application No. PCT/EP2015/075477, filed on Nov. 2, 2015.

(30) Foreign Application Priority Data
Nov. 4, 2014 (DE) 10 2014 222 517.5

(51) Int. Cl. F16K 1/226

(52) U.S. Cl. CPC F16K 1/2266; F02M 26/70

(57) ABSTRACT

A valve device for a motor vehicle, comprising a housing, a flow channel located in the housing, a flap arranged in the flow channel for closing the flow channel, the flap having regions in which a pin penetrating the flap is fastened and the pin is rotatably mounted in the housing, and a valve seat, which is arranged in the flow channel and which is in contact with the flap when the latter is in the closed position. The seal is arranged in the flow channel, the side of the seal facing the flap having a wall thickness which is greater than the rest of the cross-sectional surface, the area being opposite the flap in the closed state.

### CROSS-REFERENCE TO RELATED APPLICATIONS

This application claims the benefit of PCT Application PCT/EP2015/075447, filed Nov. 2, 2015, which claims priority to German Application DE 10 2014 222 517.5, filed Nov. 4, 2014. The disclosures of the above applications are incorporated herein by reference.

### FIELD OF THE INVENTION

The present invention is a valve device for a motor vehicle, with a housing, a flow channel located in the housing, a flap arranged in the flow channel for closing the flow channel, wherein the flap is attached to a pin and the pin is mounted rotatably in the housing, and with a valve seat which is arranged in the flow channel and is in contact with the flap when the latter is in the closed position.

### BACKGROUND OF THE INVENTION

Valve devices are used for example as throttle flap supports or exhaust gas recirculation valves, and have been known for some time. Because the flap is mounted rotatably, it is possible to close or open the flow channel completely in order thus to control the mass through-flow. Since a high regulation quality is required in particular in the range with small opening angles, particular attention is paid to the design of the flap and seal. Firstly, the seal is under high mechanical load from the opening and closing, for which reason the seal is arranged in the housing and not on the flap. Secondly, as a result of unfavorable operating conditions, ice may form in the flow channel and on the flap, which disrupts an even progress of movement of the flap. In the worst case, the ice formation may block the movement of the flap. For this reason, it is known to heat the housing of the valve device in that a channel, which is connected to the water cooling circuit of the internal combustion engine, runs around the flow channel inside the housing. The cooling water thus heats the housing. The disadvantage with this valve device is the complex housing design because of the coolant channel with associated ports. It is also known to configure the flow channel with an anti-icing coating, which however also leads to increased cost.

### SUMMARY OF THE INVENTION

The invention is based on the object of creating a valve device with which a high regulation quality is achieved in the range from a small opening angle through to complete closure of the flow channel. The valve device also avoids a blocking of the valve due to ice formation, at low cost.

The object is achieved in that the seal is arranged in the flow channel, the side of the seal facing the flap has a region of greater wall thickness than the remaining cross-section area, and this region lies opposite the flap in the closed state.

The configuration of the seal with a region of greater wall thickness than the remaining cross-section area, wherein this region lies opposite the flap in the closed state, has the result that in this way an exposed area is created so that the seal has the smallest inner diameter in this region. By arranging this region in the zone in which the flap lies when in its closed position, it is ensured that the flow channel is reliably closed when the flap is in the closed position. As a result of the greater accumulation of material in this region, a lower elasticity results which increases the sealing effect. Since this region however is formed only in the region of the closed position of the flap, the geometric expansions of this region are reduced to a minimum. As a result, loads on the seal and flap occur in a zone which is physically extremely limited, which significantly reduces the wear and hence extends the service life of the seal and the flap. Also, the arrangement of the seal in the flow channel significantly reduces the risk of damage during installation.

Depending on the diameter of the flow channel, in an advantageous embodiment, the region of greater wall thickness extends over a pivot angle range of the flap from 8° to −8°, preferably 5° to −5°, in particular from 2° to −2°, wherein for greater diameters, smaller pivot angle ranges may be selected. The closed position of the flap here corresponds to 0°.

For a particularly high quality of regulation, the region of greater wall thickness is formed as a plate in the region of the closed position of the flap.

The least wear between seal and flap is achieved if the region of greater wall thickness has a curvature pointing in the direction of the flap. This design achieves that the region in which the seal and flap touch is reduced to a spatial minimum.

The use of sealing lips allows a high elasticity over a large area, since sealing lips have a narrow cross-section area in comparison with the remaining sealing body. In order to restrict the sealing effect to a spatially small region, but nonetheless to guarantee adequate flexibility, it has proved advantageous to configure the seal with a U- or V-shaped cross-section. The desired flexibility is guaranteed by the two legs of the cross-section area which may be adjusted within certain limits via the thickness of the legs.

A high flexibility is achieved if one of the legs of the sealing cross-section faces the flap, while the other leg lies on the receiver for the seal in the flow channel.

For a very high regulation quality, the seal is arranged in the flow channel such that the apex of the U- or V-shaped cross-section area faces the flap, and the ends of the legs opposite the apex lie on the receiver of the seal in the flow channel. The contact of the legs gives the seal a precisely defined position which in this orientation allows only slight position changes of the area in contact with the flap, which finally allows a precise setting of the medium flowing through the flow channel.

In another embodiment, the seal may be produced with narrow cross-section area but adequate form stability if the seal has a reinforcing profile.

In the simplest case, the reinforcing profile is configured U- or V-shaped, corresponding to the cross-section area. In this way, the function of the legs may be supported.

The reinforcing profile may be arranged inside the cross-section area. Production of the seal is easier if the reinforcing profile is arranged extending over the inside of the legs, so that with one side it is in contact with the seal and the mutually opposite faces of the profile are freely visible.

Insofar as the reinforcing profile has a spring effect, this embodiment allows a further reduction in the cross-section area of the seal, since the elasticity of the seal need no longer be achieved exclusively via the material and its cross-section. In this way, the seal may be produced more cheaply.

Good flexibility is achieved with a seal made of an elastomer, while ice formation in the region of the seal is achieved if the seal is made of PTFE.

The arrangement of the seal is particularly simple if it is arranged in a receiver of the flow channel.

In the simplest case, the receiver is a radially peripheral groove. According to another advantageous embodiment, production of the seal is substantially cheaper if the receiver is a shoulder, and the seal lies on the shoulder.

For reliable holding of the seal in this position, a clamp ring may be provided which fixes the seal in this position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a valve device having a flap and a seal, according to embodiments of the present invention;

FIG. 2 is a sectional view of a portion of a first embodiment of a valve device having a flap and a seal, according to embodiments of the present invention;

FIG. 3 is a sectional view of a portion of a second embodiment of a valve device having a flap and a seal, according to embodiments of the present invention;

FIG. 4 is a sectional view of a portion of a third embodiment of a valve device having a flap and a seal, according to embodiments of the present invention;

FIG. 5 is a sectional view of a portion of a fourth embodiment of a valve device having a flap and a seal, according to embodiments of the present invention;

FIG. 6 is a sectional view of a portion of a fifth embodiment of a valve device having a flap and a seal, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

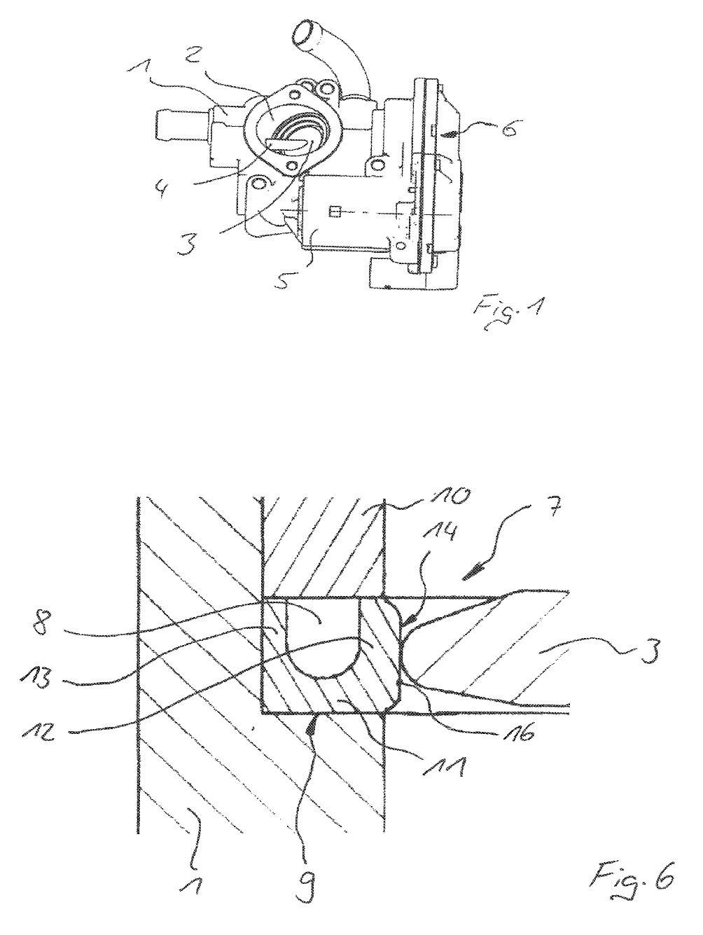

FIG. 1 shows a throttle flap connector as a valve device, with a housing 1, a flow channel 2 which is situated in the housing and in which a disc-like flap 3 is arranged. The flap 3 is fixedly connected to a pin 4, and the pin 4 is mounted rotatably in the housing 1. The pin 4 is driven by an electric motor 5 via a gear mechanism 6.

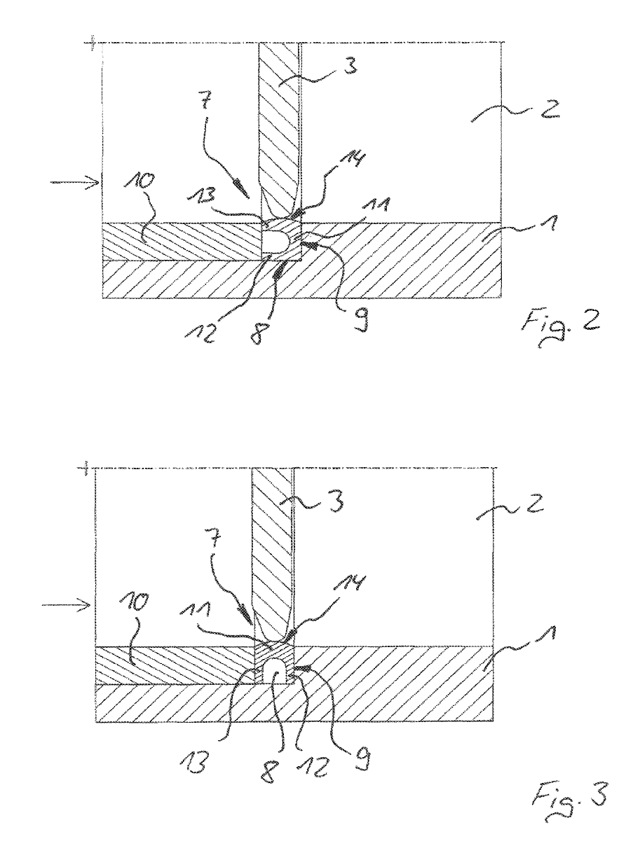

The cylindrical region in which the flap 3 seals the flow channel 2 is the valve seat 7. The flow direction in the flow channel 2 is identified with an arrow. FIG. 2 shows the flap 3 in the closed position in the flow channel 2. For this, the flap 3 lies on a seal 8. The seal 8 lies on a shoulder of the flow channel 2 formed as a receiver 9, and is fixed in this position by a clamp ring 10. The seal 8 has a U-shaped cross-section, wherein the apex 11 and a leg 12 of the seal 8 lie on the shoulder 9, and a leg 13 is in contact with the flap 3. The leg 13 facing the flap 3 has a greater wall thickness than the other leg 12 and the apex 11. The region of greater wall thickness 14 is configured as a curvature facing the flap 3, in order to allow a precise seal of the flow channel 2 by the flap 3.

The seal in FIG. 3, compared with the seal in FIG. 2, has a cross-section area rotated through 90° with a radially inner apex 11. In the closed position, the flap 3 lies against this apex 11, wherein the apex 11 has a greater wall thickness than the legs 12, 13.

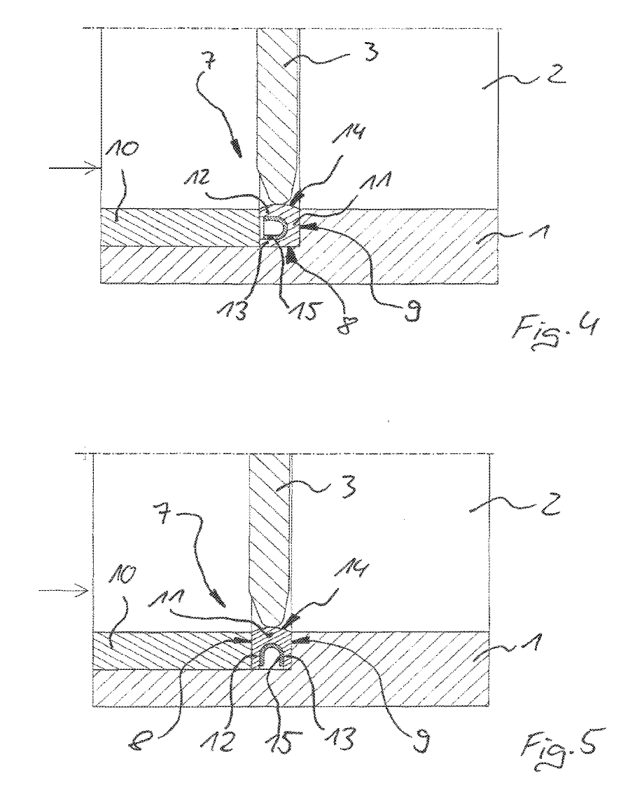

FIGS. 4 and 5 show seals 8 in the orientation according to FIGS. 2 and 3, wherein the seals 8 differ in that they each have a reinforcing profile 15 to support the form stability. The reinforcing profile 15 is arranged on the respective inside of the legs 12, 13. It is however also conceivable to arrange the reinforcing profile 15 completely inside the seal 8 so that it is not visible.

The seal 8 in FIG. 6 differs in structure from the seal 8 in FIG. 2 in that the region of greater wall thickness 14 is formed not as a curvature but as a plate 16. Such an embodiment is also possible with the seals 8 of FIGS. 3-5.

The description of the invention is merely exemplary in nature and, thus, variations that do not depart from the gist of the invention are intended to be within the scope of the invention. Such variations are not to be regarded as a departure from the spirit and scope of the invention

What is claimed is:

1. A valve device for a motor vehicle, with
a housing;
a flow channel located in the housing;
a flap arranged in the flow channel for selectively closing the flow channel, the flap having an open position and a closed position;
a pin extending through the flap such that the flap is mounted to the pin, the pin being rotatably mounted in the housing;
a valve seat located in the flow channel, the flap being in contact with the valve seat when the flap is in the closed position; and
a seal having a cross-sectional area which includes a region of greater wall thickness in relation to the remaining cross-sectional area;
wherein the seal is arranged in the flow channel such that flap is in contact with the region of greater wall thickness when the flap is in the closed position.

2. The valve device of claim 1, wherein the region of greater wall thickness extends over a pivot angle range of the flap from 8° to −8°.

3. The valve device of claim 1, wherein the region of greater wall thickness extends over a pivot angle range of the flap from 5° to −5°,.

4. The valve device of claim 1, wherein the region of greater wall thickness extends over a pivot angle range of the flap from 2° to −2°.

5. The valve device of claim 1, wherein the region of greater wall thickness further comprising a plate, the flap being in contact with the plate when the flap is in the closed position.

6. The valve device of claim 1, the region of greater wall thickness further comprising a curvature, wherein the curvature is exposed to the flap.

7. The valve device of claim 1, further comprising:
a receiver formed as part of the flow channel such that the receiver is part of the valve seat;
a plurality of legs formed as part of the seal;
wherein the seal is located in the flow channel such that one of the legs is in contact with the receiver, and another of the legs is in contact with the flap when the flap is in the closed position.

8. The valve device of claim 7, wherein the cross-sectional area of the seal is one selected from the group consisting of a U-shaped cross-section and a V-shaped cross-section.

9. The valve device of claim 8, further comprising:
an apex being part of the cross-sectional area of the seal;
wherein the apex of the cross-sectional area is in contact with the flap when the flap is in the closed position, and the ends of each of the plurality of legs are in contact with the receiver.

10. The valve device of claim 7, the seal further comprising a reinforcing profile.

11. The valve device of claim 10, the reinforcing profile further comprising a cross-sectional area which corresponds to the cross-sectional area of the seal.

12. The valve device of claim 11, wherein the reinforcing profile is disposed between two of the plurality of legs.

13. The valve device of claim 10, wherein the reinforcing profile operates as a spring.

14. The valve device of claim 7, wherein the seal is located in the receiver of the flow channel.

15. The valve device of claim 14, wherein the receiver is a radially peripheral groove.

16. The valve device of claim 14, further comprising:
a shoulder formed as part of the receiver; and
a clamp ring at least partially disposed in the flow channel;
wherein the seal is in contact with the shoulder, and the clamp ring fixes the seal in this position.

17. The valve device of the claim 1, wherein the seal is made from a material selected from the group consisting of an elastomer and PTFE.
